(19) United States
(12) Patent Application Publication
(10) Pub. No.: US 2007/0018612 A1
(43) Pub. Date: Jan. 25, 2007

(54) Standalone bus bar kit system

(76) Inventor: Jerry R. VanLuvanee JR., Lyon Station, PA (US)

Correspondence Address: ZACHARTY T. WOBENSMITH, III, 7746 101st Court, Vero Beach, FL, 32967-2871, US

(21) Appl. No.: 11/176,869

(22) Filed: Jul. 8, 2005

(51) Int. Cl. H02J 7/00

(52) U.S. Cl. 320/116

(57) ABSTRACT

Standalone bus bar kit system having two uprights mounted to a floor mounting base, a center mounting bracket connecting the uprights in the middle, upper mounting, brackets connecting the uprights at the top, positive and negative bus bars mounted to insulators carried by the uprights, and which have battery strings connected thereto, and a detachable protective shield carried on insulators on one of the bus bars.

### BACKGROUND OF THE INVENTION

1. Field of the Invention

This invention relates to a standalone bus bar kit system for connecting individual battery strings to create a common bus.

2. Description of the Prior Art

Batteries of the sealed lead-acid type are in widespread use for stand by power in the telecommunication industry, and by other users, where uninterruptible electric power is required. In these applications, there is often a need for increased power or extended runtime.

Multiple strings of batteries are often used to satisfy these requirements.

One way to accomplish this is to parallel individual strings of cells within a battery. This is not a satisfactory solution as maintenance or change out of a cell requires that the whole battery system be shut down, which leaves no power back up. Another and more common method is to series connect individual strings of batteries, and then parallel the strings together at a common bus. This provides a way of taking individual strings off-line for maintenance, without shutting down the entire system.

The system of the invention is intended to take individual strings of batteries and create a common bus to which the strings are connected.

### SUMMARY OF THE INVENTION

A standalone bus bar kit system which has two uprights mounted to a floor mounting base, a center mounting bracket connects the uprights together in the middle, a two piece upper mounting bracket connects them together at the top, and negative and positive bus bars are mounted to the uprights by glastic insulators, with individual strings of batteries connected to the bus bars to create a common bus.

The principal object of the invention is to provide a standalone bus bar kit system that can be used with a variety of different batteries.

A further object of the invention is to provide a system that can be mounted to the side of a battery, to the floor, or to a wall of the battery room.

A further object of the invention is to provide a system to which a plurality of battery strings can be connected and disconnected.

A further object of the invention is to provide a system, which is simple and inexpensive to construct but sturdy and reliable in use.

A further object of the invention is to provide a system where the battery can be assembled prior to the assembly of the bus bar kit system, providing greater layout flexibility for the battery room.

A further object of the invention is to provide a system, which has a protective shield thereon.

Other objects and advantageous features of the invention will be apparent from the description and claims.

### DESCRIPTION OF THE DRAWINGS

The nature and characteristic features of the invention will be more readily understood from the following description taken in connection with the accompanying drawings forming part hereof in which:

FIG. 1 is a front perspective view of the standalone bus bar kit system of the invention, mounted to a battery;

FIG. 2 is an exploded front perspective view of the system of the invention, and

FIG. 3 is an exploded front perspective view of the system of the invention, illustrating the protective shield.

It should of course be understood that the description and drawings herein are merely illustrative, and that various modifications and changes can be made in the methods, structures, and embodiments disclosed without departing from the spirit of the invention.

### DESCRIPTION OF THE PREFERRED EMBODIMENT

When referring to the preferred embodiment, certain terminology will be utilized for the sake of clarity. Use of such terminology is intended to encompass not only the described embodiment, but also technical equivalents, which operate and function in substantially the same way to bring about the same result.

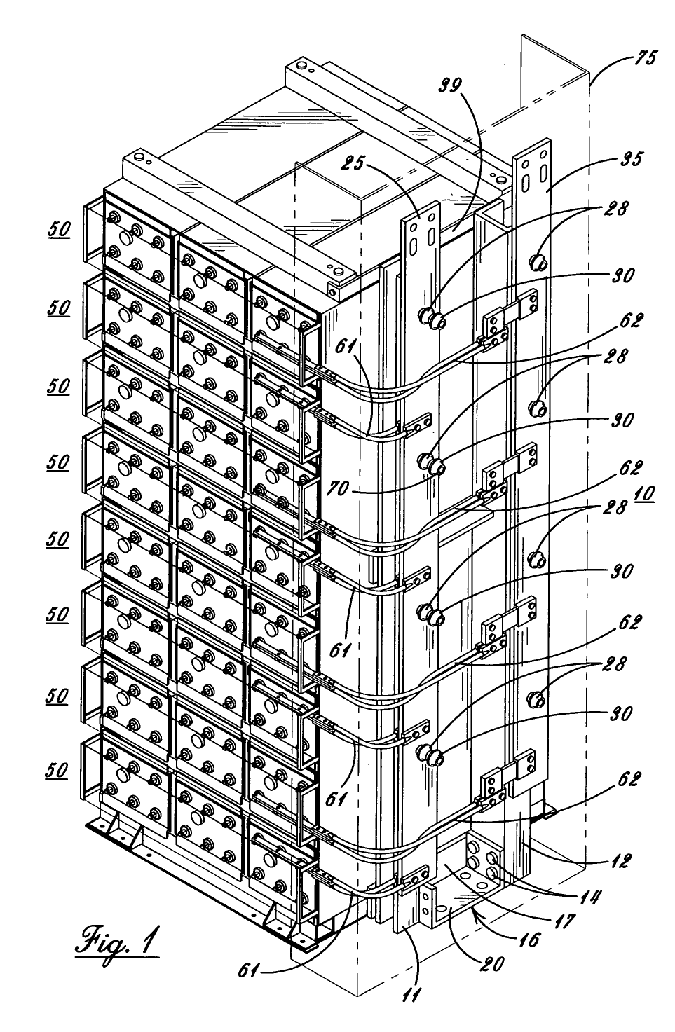

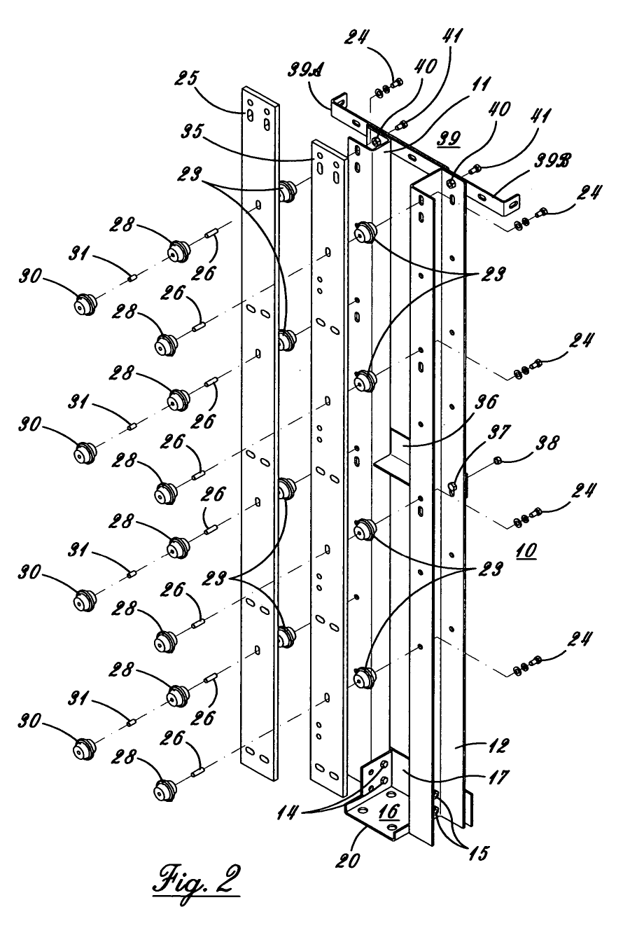

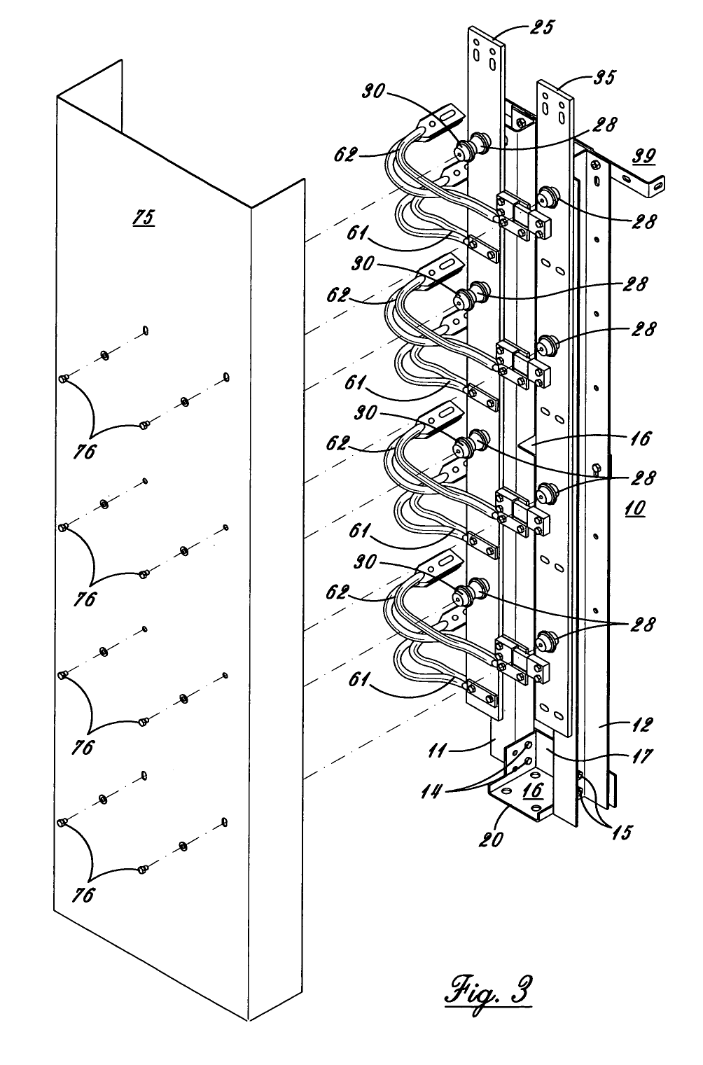

Preferring now more particularly to the drawings and FIGS. 1-3 thereof the standalone bus bar kit system 10 is therein illustrated. The system 10 includes a pair of uprights 11 and 12, which are U shaped and mounted by bolts 14 and nuts 15 to a floor mounting base 16. The base 16 is preferably constructed from a single piece of metal, preferably of steel, with a back plate 17, and a bottom plate 20 for mounting to a floor (not shown). The upright 11 has a plurality of spaced glastic insulators 23, of well known type, mounted thereto by bolts 24 extending through the upright 11 into insulators 23. A positive bus bar 25 is mounted to insulators 23 by studs 26 extending into insulators 23 through bus bar 25 into glastic insulators 28 with the bus bar 25 therebetween. Another set of glastic insulators 30 is provided, with studs 31 engaged in insulators 28 and 30 retaining them together

The upright 12 has a plurality of glastic insulators 23 mounted thereto by bolts 24, extending through the upright 12 into insulators 23. A negative bus bar 35 is mounted to insulators 23 by studs 26, extending into insulators 23 through bus bar 35 into glastic insulators 28, with the bus bar 35 therebetween.

A center mounting bracket 36 is provided, connected to the uprights 11 and 12 by bolts 37 and nuts 38, to retain and separate the uprights 11 and 12.

An upper mounting bracket 39 of two piece L-shaped construction, 39A and 39B is provided, connected to the uprights 11 and 12 by bolts 40 and nuts 41.

In FIG. 1, a plurality of battery strings 50 are illustrated, which can be as shown in my copending U.S. patent application Ser. No. ______, but which can be any suitable system. The battery strings 60 are connected to the positive bus bar 11 by cables 61, of well known type, and are connected to the negative bus bar 35 by cables 62, also of well known type.

A U shaped plastic shield 75 is provided, which extends around the system 10, and is retained thereto by bolts 76 which extend into insulators 28, and or 30. It should be noted that the base 16, the uprights 11 and 12, the center mounting bracket 36, and the upper mounting bracket 39 are preferably constructed of steel. The bus bars 25 and 35 are preferably formed of copper.

It will thus be seen that a standalone bus bar kit system has been described with which the objects of the invention are achieved.

1. (canceled)

2. A standalone bus bar kit system as defined in claim (3) in which
said base, said uprights,
said center mounting bracket, and
said upper mounting bracket are of steel, and
said bus bars are of copper.

3. A standalone bus bar kit system to which battery strings are connected which comprises,
a floor mounting base,
a pair of uprights mounted to said base,
a center mounting bracket mounted to said uprights,
an upper mounting bracket connected to said uprights for mounting said system to a battery,
a plurality of insulators carried by and retained to said uprights,
a positive bus bar mounted by studs to said insulators on one of said uprights,
a negative bus bar mounted by studs to said insulators on the other of said uprights,
a plurality of insulators mounted to said studs on the outside of said bus bars,
additional insulators mounted to studs from said plurality of insulators on at least one of said bus bars, and
a plastic shield detachably mounted to said additional insulators.
